(19) United States
(12) Patent Application Publication
(10) Pub. No.: US 2006/0000521 A1
(43) Pub. Date: Jan. 5, 2006

(54) Board fencing system

(76) Inventors: Edward Komori, Eugene, OR (US); Mark L. Carter, Springfield, OR (US); Keith McDougal, Eugene, OR (US)

Correspondence Address: DELLETT AND WALTERS, P. O. BOX 2786, PORTLAND, OR, 97208-2786, US

(21) Appl. No.: 10/927,419

(22) Filed: Aug. 25, 2004

Related U.S. Application Data
(60) Provisional application No. 60/584,906, filed on Jun. 30, 2004.

(51) Int. Cl. B26D 3/00; B27B 1/00; B23Q 15/00; B23Q 16/00; B27C 1/12; B27C 5/02; B27B 31/00

(52) U.S. Cl. 144/357; 144/394; 144/242.1

(57) ABSTRACT

A fence system and method employs a conveyor to convey boards in a travel direction towards trim saws. A board engaging foot member presses against a face of the board as the board moves through an area, and the foot member is translated at an angle relative to the travel direction so that the board can be accurately positioned laterally to a desired position while the board continues to move through the conveyor.

### BACKGROUND OF THE INVENTION

This invention relates to wood products, and more particularly to a fencing system and method for use in a sawmill for accurately positioning boards.

In sawmill operation, boards travel along a conveyor and are trimmed to length (say for example, if 2 by 4 boards are being produced, they will be cut to a specific length). Systems exist for moving the boards from side to side as they travel down the conveyor, to position them relative to trim saws for cutting the boards to the specific length. However, the existing systems tend to lose accuracy at higher speeds. Some such systems employ guide members that flip up to interact with a board, to cause the board to move to one side or another by interaction with the guide member. AS the speed of the board is increased, as the board travels past the guide member, the likelihood of the board to moving farther than was intended will increase. The board's impact with the guide at higher speed causes the board to bounce or otherwise move beyond the desired amount. This leads to variations in board length or imperfections remaining in a board because of inaccurate positioning relative to a trim saw which was intended to cut away the imperfect portion, which diminishes the value of the product, as it will be less desirable to customers having precise length or quality requirements.

### SUMMARY OF THE INVENTION

In accordance with the invention, a fence system and method is provided to accurately and precisely position a board so that it is oriented to be trimmed to a desired length, while enabling higher throughput than provided by the prior art.

Accordingly, it is an object of the present invention to provide an improved board positioning system.

It is a further object of the present invention to provide an improved board position system and method for enabling production of precise board lengths.

It is yet another object of the present invention to provide an improved system for trimming boards.

The subject matter of the present invention is particularly pointed out and distinctly claimed in the concluding portion of this specification. However, both the organization and method of operation, together with further advantages and objects thereof, may best be understood by reference to the following description taken in connection with accompanying drawings wherein like reference characters refer to like elements.

### BRIEF DESCRIPTION OF THE DRAWINGS

FIG. 1 is a perspective view, partially broken away, of the system according to the invention;

FIG. 2 is a top view of the system of FIG. 1;

FIG. 3 is a side view taken along line 3-3 of FIG. 2; and

FIG. 4 is an isometric view of the board positioning mechanism;

FIG. 5 is a view of the board positioning mechanism in an extended position;

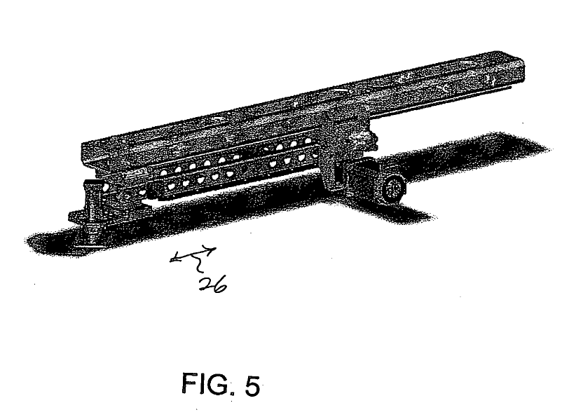

FIG. 6 is a view of the board positioning mechanism in an retracted position;

FIG. 7 is another view of the board positioning mechanism in an retracted position;

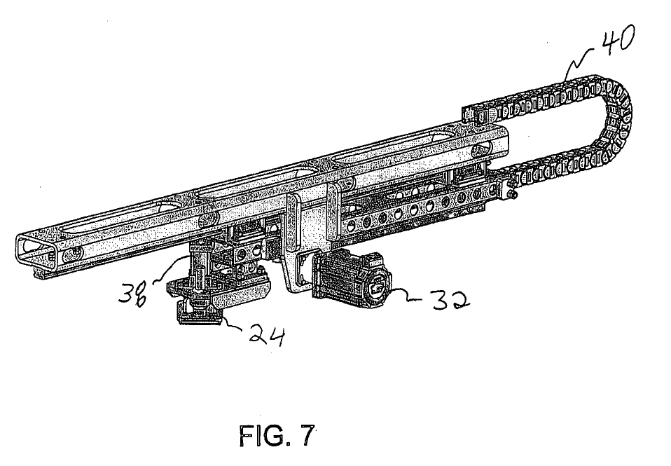

FIG. 8 is a perspective view of a portion of the board positioning system;

FIG. 9 is a side view of a portion of the board positioning system;

FIG. 10 is an end elevational view of the board positioning system;

FIG. 11 is an isometric view of a board position system with plural board positioners installed;

FIG. 12 is a top view of the system of FIG. 11;

FIG. 13 is a perspective view of the board clamping mechanism as viewed from below; and

FIG. 14 is a simplified block diagram of the operation system.

### DETAILED DESCRIPTION

The system according to a preferred embodiment of the present invention comprises a fence apparatus and method for accurately positioning boards for presentation to a trim saw.

In the Figures, a conveyor 12 moves the boards towards trim saws (not shown). The conveyor illustrated includes plural board engagers 15 which interact with the board to move the board in the travel direction indicated by arrow 14. The boards pass through a scanner 16 which determines the board's configuration, which may include such information as length and any noted defects which are to be removed by trimming. A low friction surface area 18, which may comprise an ultra high molecular weight polyethylene, for example, is provided in one region and above that surface, a translation device 22 is employed that has a pneumatically actuated foot member 24 that moves up and down so as to press against the top surface of a board as it passes underneath. The foot member is movable on a translation direction 26, suitably at 45 degrees to the direction of travel 14 of the conveyor in this embodiment. As a board passes along, the scanner indicates the characteristics of the board, which may include imperfections that are desired to be trimmed off the board. As the board moves under the foot member, the foot is translated downwardly in the direction of arrow 28 and presses against the top of the board 30. The foot member is simultaneously translated along the translation direction, which causes the board to move along the axis of arrow 20, side to side, so as to be at the desired position so that the end is trimmed properly. Since the foot translates at an angle to the movement direction of the conveyor (suitably 45 degrees), during the brief period of time that the foot is engaged with the board, the travel speed of the foot in the conveyor direction matches the speed of the board and allows accurate side to side position adjustment of the board (suitably at 90 degrees to the conveying direction in the illustrated embodiment) without disruption of the board's momentum in the direction of arrow 14. When the board is at the desired position, the foot is moved upwardly opposite of direction arrow 28, and the board continues down the conveyor for cutting by the end trim saw.

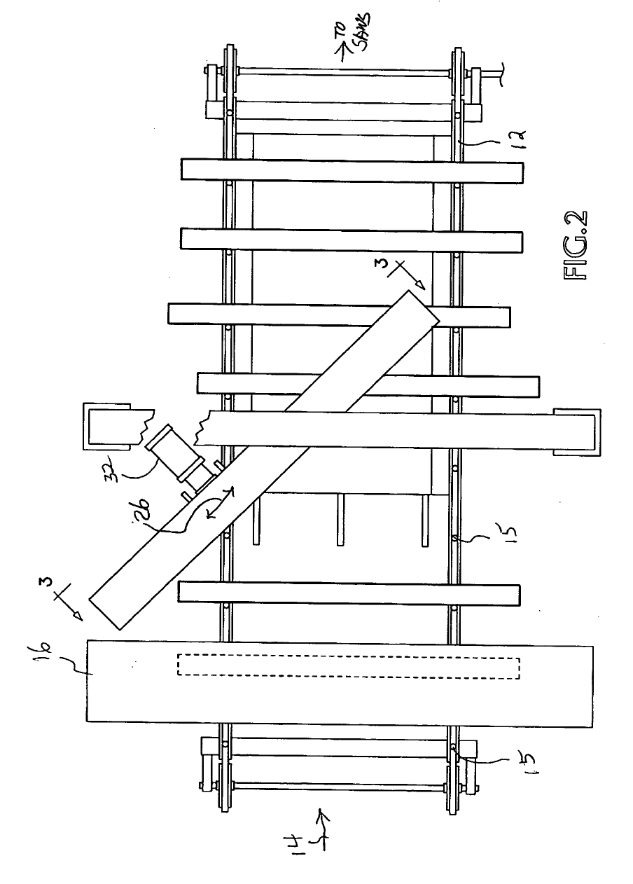

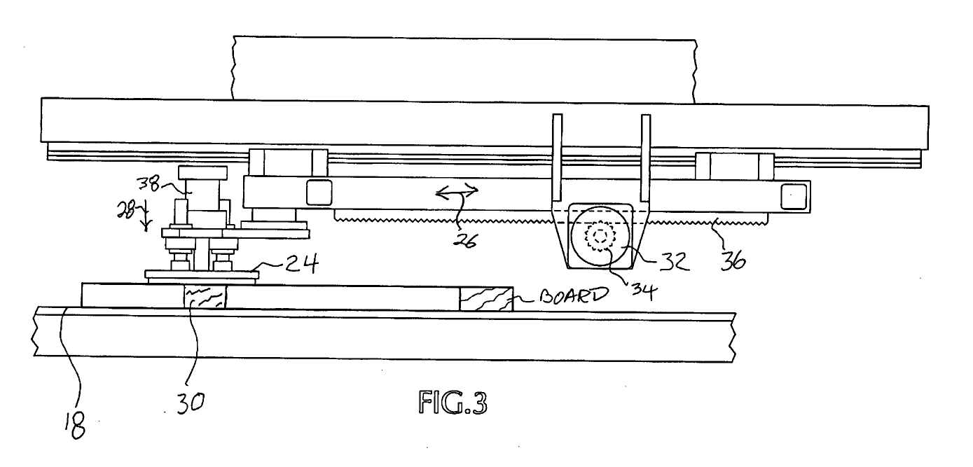

Referring now to FIG. 3, a side view showing the board translating mechanism, taken along line 3-3 in FIG. 2, the mechanism includes a drive motor 32 having a pinion gear 34 that engages with rack 36 attached to a support carrying the pneumatically actuated foot member 24, whereby operation of the motor causes translation of the foot member along axis 26.

Pneumatic actuator 38 is operative to provide downward and upward motion of the foot member as indicated by arrow 28.

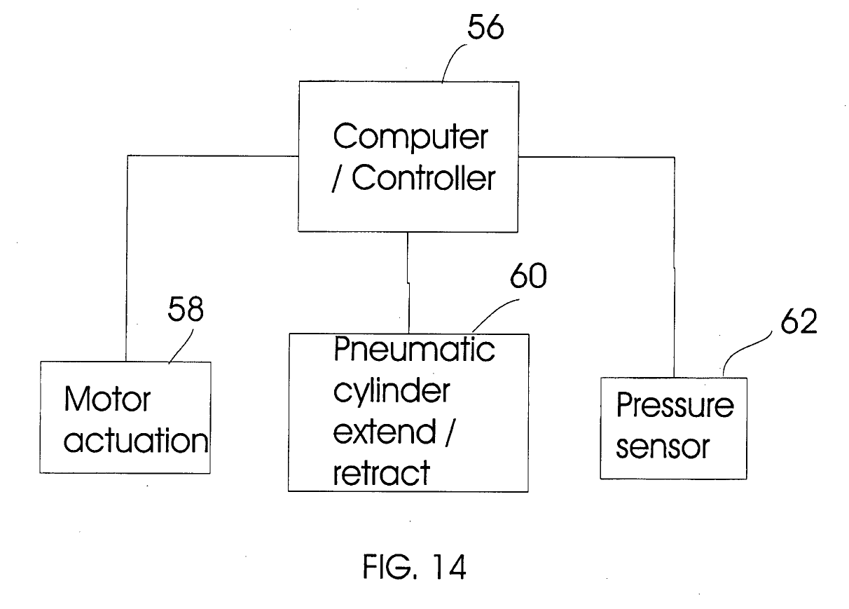

In operation, the conveyor operates and supplies boards, typically one by one, from a board supply not shown. The conveyor passes the board through the scanner 16, whereupon any defects or other information about the board is determined, and under operation of a computer (FIG. 14), for example, which is programmed with the desired cutting configuration, when the board passes underneath the positioning mechanism, the pneumatic actuator 38 is operated to extend the foot member downwardly in the direction of arrow 28, so as to engage the top surface of the board. The motor 32 is then actuated to translate the foot member (and consequently, the board) along the axis 26, which thereby positions the board laterally on the axis 20. When the board has been moved a desired amount so as to be positioned to be oriented for cutting by trim saws at a desired location, the foot is retracted (by operation of pneumatic actuator 38).

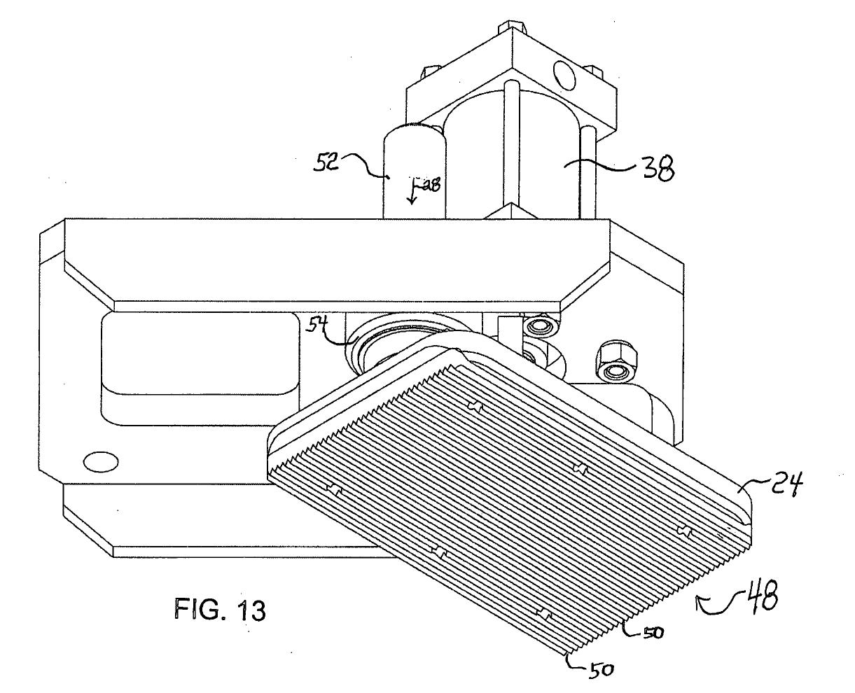

FIG. 13 is an enlarged perspective view of the pneumatic actuator 38 and foot member 24. The face of the foot member that interacts with the board face suitably comprises a hardened steel “vee” grooved plate 48, which may be attached by use of bolts for example, to enable removal and replacement as the plate 48 such as for wear or damage thereto from repeated contact with the boards. The “vee” grooves 50 in the illustrated embodiment suitably run parallel to one another along a direction across the plate. An alternate plate 48 may comprise vulcanized rubber, for example. The actuator in the illustrated embodiment employs two sliding guide member 52 (one being visible in this view) adapted to translate upwardly and downwardly with the extension/retraction of the pneumatic cylinder via bearings 54 mounted in the support frame of the actuator, to provide a more stable foot member.

FIG. 14 is a simplified block diagram of the operation/control system employed with the device. A computer or controller 56 communicates with motor actuation block 58 (which drives the motor 32 for directing the operation of the translation mechanism), pneumatic cylinder extend/retract block 60 (which extends and retracts the pneumatic cylinder 38) and pressure sensor 62 (which detects and reports the pressure within the pneumatic cylinder/system). Also, either separately or as a portion of the same controller, input from the scanner 16 may be employed in determining how to position the board for trimming.

To determine the extent to move the foot member downwardly in order to engage a board, the following method is used. As the foot moves downwardly with the extension of the pneumatic actuator 38, at some point in time the foot will contact the board. The actuator includes pressure sensor 62 thereon to sense the internal pressure of the pneumatic actuator system. When the foot 24 and plate 48 is contacting the board, the pressure will begin to increase because the pneumatic cylinder is impeded against further extension. This pressure increase feedback is observed by the operating computer or controller 56 running the system, whereupon the extension of the pneumatic cylinders is then halted. Once the board has been moved to the desired location, the pneumatic cylinder is retracted to remove the foot from interaction with the board.

The accurate positioning of the board is desirable, as it enables the board to be adjusted prior to cutting, so that any defects which may be present near ends of the board will be in the waste portion of the board that is cut away by the trim saws. This enables a higher quality lower defect board production to be accomplished at high speed.

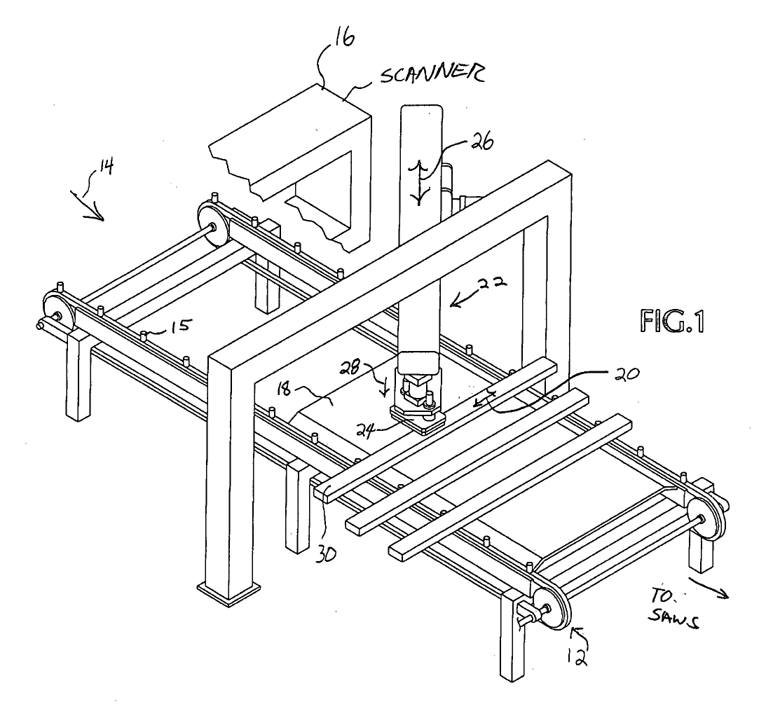

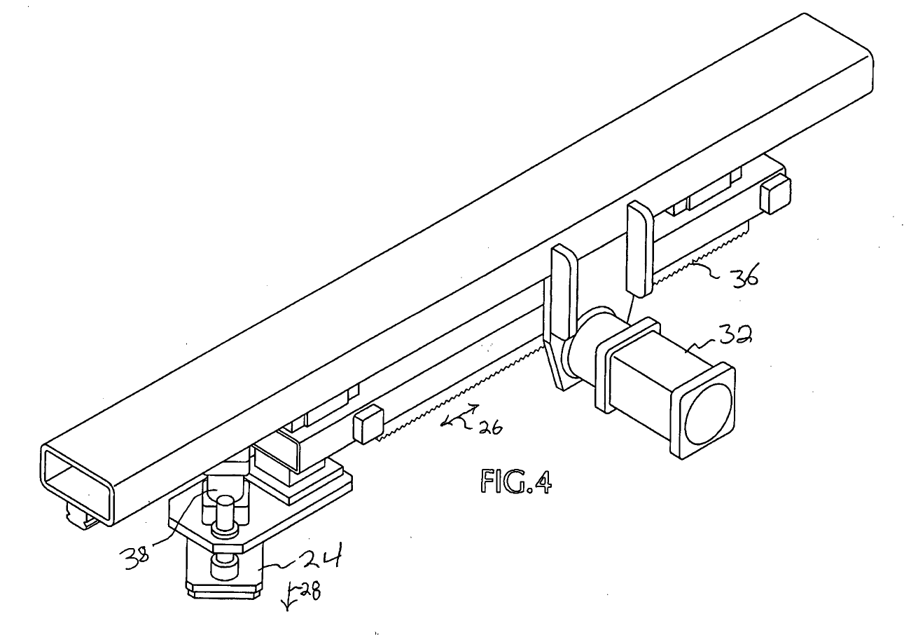

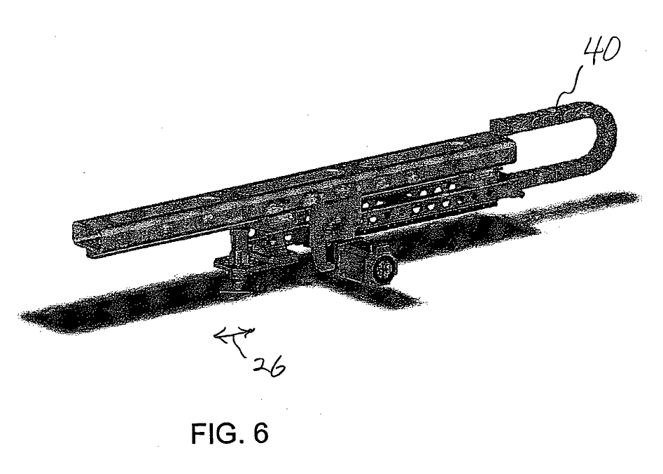

For clarity of illustration in FIGS. 1-4, flexible control/power cable system 40 has been removed, but is visible in FIG. 6, for example, providing operational power and control to the motor 32 and pneumatic actuator 38.

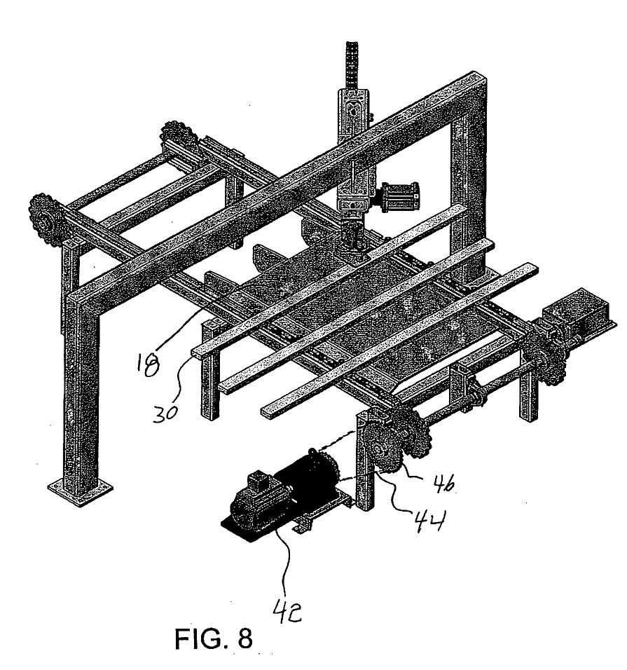

FIG. 8 is a perspective view which illustrates drive motor 42 powering the conveyor system 12, via drive chain 44 and its interaction with the conveyor 12.

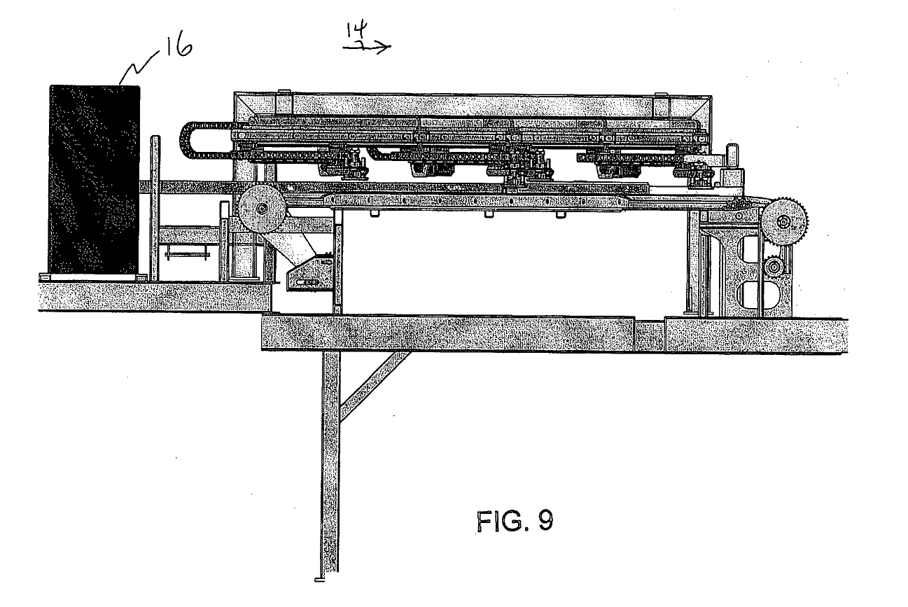

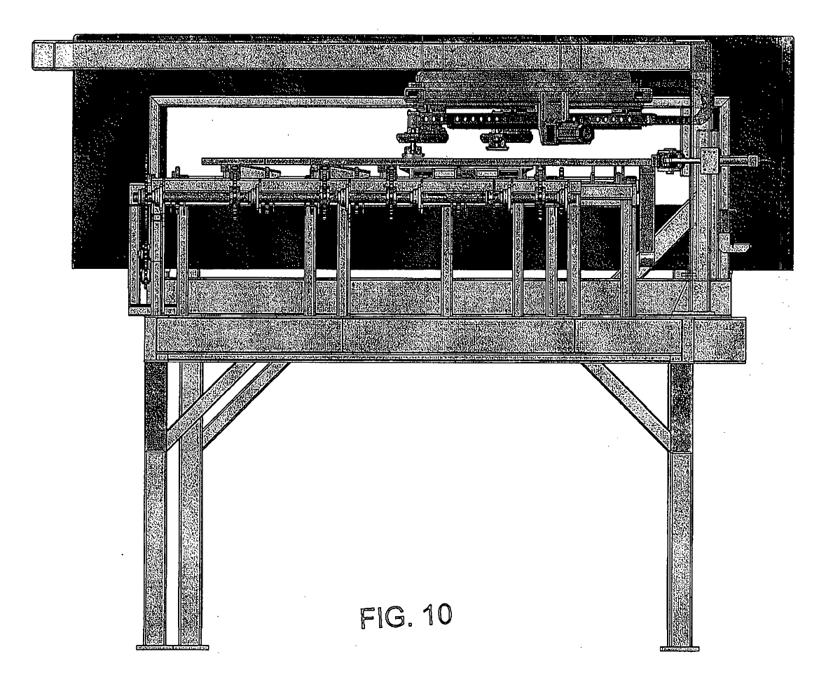

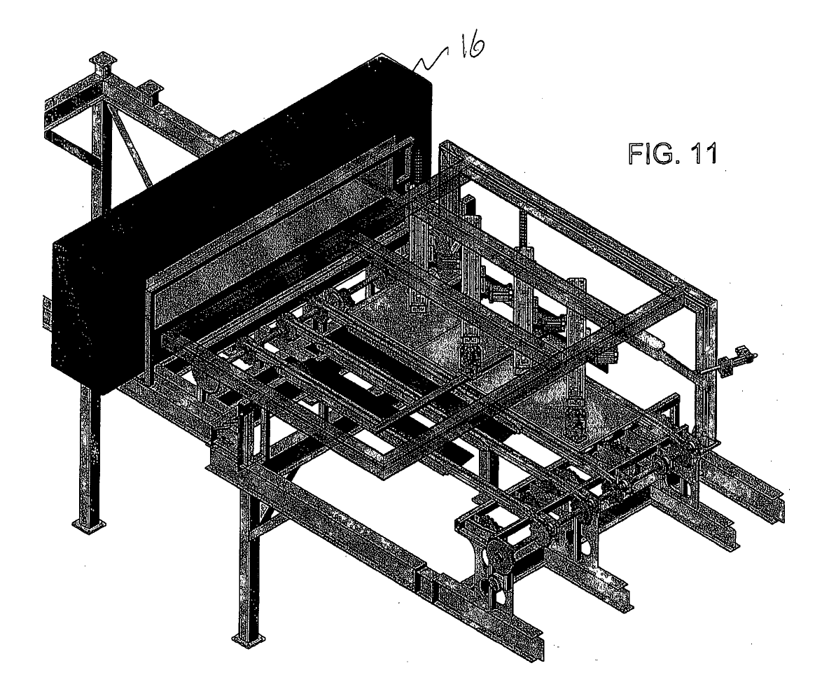

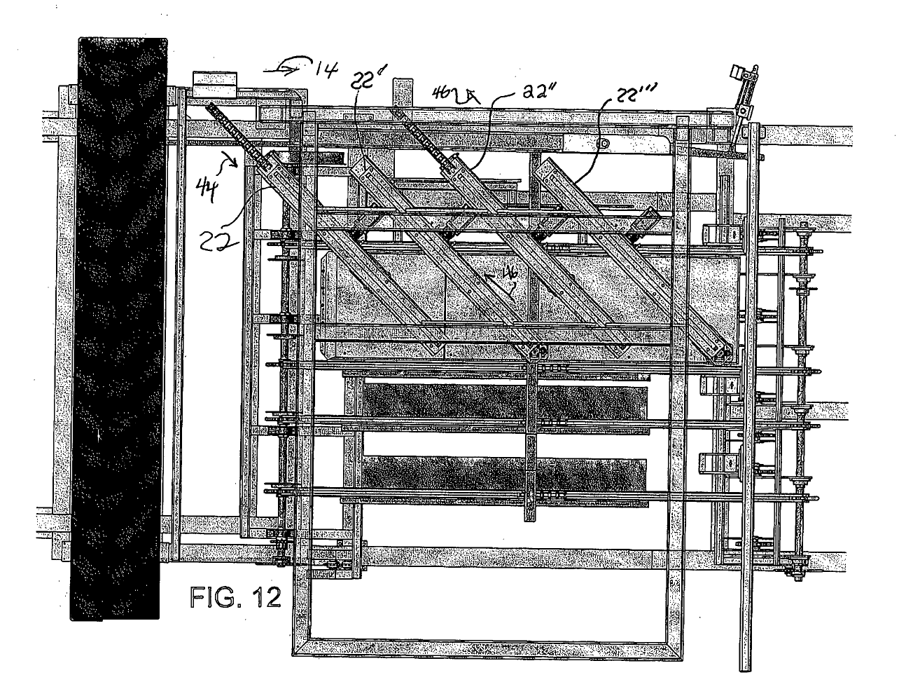

FIGS. 9-12 illustrate a board fencing system with plural board translating devices 22, 22′, 22″ 22′″ positioned in spaced arrangement along the direction of movement of the conveyor. In this configuration, the translating devices are arranged alternately in their orientation, wherein devices 22 and 22″ are oriented so that extension is in the direction of arrow 44, while devices 22′ and 22′″ are oriented so that their extension operation is in the direction of arrow 46.

The use of plural translating devices enables multiple boards to be positioned at the same time, enabling higher throughput.

Thus, in accordance with the above described system and method, an improved fence system for accurately positioning boards for feeding to trim saws is provided. The system and method enable high speed yet accurate positioning of the boards to provide a high quality end product.

While plural embodiments of the present invention have been shown and described, it will be apparent to those skilled in the art that many changes and modifications may be made without departing from the invention in its broader aspects. The appended claims are therefore intended to cover all such changes and modifications as fall within the true spirit and scope of the invention.

What is claimed is:

1. A fence system for positioning boards, comprising:
an engaging member for engaging a board; and
a translation device for translating the engaging member and board to a desired position.

2. The system according to claim 1, further comprising a low friction translation area in which the engaging member engages the board.

3. The system according to claim 1, further comprising a conveying system for conveying the boards in a conveyance direction at a conveying speed, wherein said translation device translates said engaging member at an angle relative to the conveying direction so as to enable the boards to remain moving in the conveying direction at substantially the conveying speed.

4. The system according to claim 1 wherein said engaging member comprises an extensible/retractable foot member for engaging the board.

5. The system according to claim 4, wherein said engaging member further comprises a pneumatic driving device for extending/retracting said extensible/retractable foot member.

6. The system according to claim 5, further comprising a controller/sensor for determining when said foot member is in contact with a board.

7. The system according to claim 6, wherein said controller/sensor comprises a pneumatic pressure sensor for determining pressure within said pneumatic driving device and wherein said controller is operative to control the extension based on pressure determinations by said pneumatic pressure sensor.

8. The system according to claim 1, further comprising a scanner for scanning a board to determine the desired position thereof.

9. A method of positioning a board, comprising;
conveying the board along a first travel direction;
engaging the board with an engager;
translating the engager at a first angle relative to the travel direction while the conveying is continued, thereby translating the board in a direction at a second angle relative to the travel direction.

10. The method according to claim 9, wherein said first angle is substantially 45 degrees relative to the travel direction.

11. The method according to claim 9, wherein said second angle is substantially 90 degrees relative to the travel direction.

12. The method according to claim 9, wherein said board engager comprise a pneumatically operated board engaging foot member.

13. The method according to claim 12, further comprising sensing pneumatic pressure within the pneumatically operated board engaging foot member to determine whether the foot member has engaged the board.

14. The method according to claim 9, further comprising scanning the board to determine a desired position, said determination being employed to determine the amount of translation to be performed in said translating step.

15. The method according to claim 9, wherein said translating is performed at a translation area comprising a low friction surface.

16. A board fencing system for positioning a board, comprising:
a scanner for detecting board parameters and for determining a board position based thereon;
a conveyor for moving the board in a direction in a substantially continuous manner; and
a positioner for engaging the board and for both transversely moving the board and for moving the board in the conveying direction without substantially interrupting the continuous movement of the board in the direction by the conveyor.

17. The board fencing system according to claim 16, wherein said positioner comprises a board engaging foot member adapted to translate at an angle to the direction while in engagement with the board.

18. The board fencing system according to claim 17, wherein said positioner further comprises a pneumatic actuator for moving said foot member into engagement with the board.

19. The board fencing system according to claim 18, further comprising a sensor system to detect when the foot member is in engagement with the board.

20. The board fencing system according to claim 19, wherein said sensor system comprises a pressure sensor for detecting pressure of a pneumatic system of the pneumatic actuator and a controller for directing operation of the pneumatic actuator based thereon.
